(19) United States
(12) Patent Application Publication
(10) Pub. No.: US 2019/0347769 A1
(43) Pub. Date: Nov. 14, 2019

(54) INFORMATION PROCESSING DEVICE, INFORMATION PROCESSING METHOD AND STORAGE MEDIUM

(71) Applicant: NEC Corporation, Minato-ku, Tokyo (JP)

(72) Inventors: Kapik LEE, Tokyo (JP); Takashi SHIBATA, Tokyo (JP); Atsushi SATO, Tokyo (JP)

(73) Assignee: NEC Corporation, Minato-ku, Tokyo (JP)

(21) Appl. No.: 16/475,719

(22) PCT Filed: Jan. 12, 2017
(86) PCT No.: PCT/JP2017/000742

§ 371 Date: Jul. 3, 2019

(51) Int. Cl. G06T 3/40; G06T 5/00; G06T 5/50

(52) U.S. Cl. CPC G06T 3/4076; G06T 3/4069; G06T 5/50; G06T 5/001

(57) ABSTRACT

An information processing device includes at least one memory that stores a set of instructions, and at least one processor configured to execute the set of instructions to: generate bases and first coefficient sets from first data; determine a second coefficient set based on the first coefficient sets; and synthesize second data by using the bases and the second coefficient set. The bases with each of the first coefficient sets represent a piece of the first data. The second coefficient set is different from the first coefficient sets.

### TECHNICAL FIELD

The present invention is related to an information processing technology, especially to an image processing technology.

### BACKGROUND ART

A super resolution system of exemplar based super resolution, which provides high resolution output based on examples, usually includes a database which provides high frequency information for reconstruction of the high resolution output.

PTL 1 discloses an information processing apparatus that generates a reconstructed image from a lower-resolution image whose resolution is lower than that of the reconstruction image by using a dictionary including degradation patches and reconstruction patches. The reconstruction patches are partial images of predetermined images generated by dividing the predetermined images. The degradation patches are partial images of degradation images generated by degrading the predetermined images. The frequencies of the reconstruction patches are higher than those of the degradation patches.

PTL 2 discloses a dictionary generation apparatus that generates a dictionary including the degradation patches and the reconstruction patches.

PTL 3 discloses an image processing apparatus that generates a high-frequency basis dictionary and a middle-frequency basis dictionary from patch combinations. Each of the patch combinations includes a high-frequency patch and a middle frequency patch. The high-resolution patch is a partial image of a high-frequency image representing a high-frequency component of an input image. The middle-resolution patch is a partial image of a middle-frequency image representing a middle-frequency component of the input image.

PTL 4 discloses an image generation apparatus that generates a morphing image on the basis of three or more source images and feature vectors of the source images. The feature vectors represent characteristic lines or the like in the source images.

NPL 1 discloses a method of synthesizing a high-resolution face image from a low-resolution image with the help of a large collection of other high-resolution face images.

### CITATION LIST

### Patent Literature

[PTL 1]
PCT International Application Publication No. WO2013/089261
[PTL 2]
PCT International Application Publication No. WO2013/089265
[PTL 3]
Japanese Unexamined Patent Application Publication No. 2015-176500
[PTL 4]
Japanese Unexamined Patent Application Publication No. 2012-164152

### Non Patent Literature

[NPL 1]
Liu Ce, Heung-Yeung Shum, and William T. Freeman, “Face Hallucination: Theory and Practice,” International Journal of Computer Vision 75(1), pp. 115-134, 2007.

### SUMMARY OF INVENTION

### Technical Problem

The above-described database in the super-resolution system may lead to a privacy problem because the database may include personal information, such as face images. The privacy of the database in the super-resolution system is not protected when the super resolution system is sold or distributed to users.

For example, a database according to the technologies of PTL 1 and PTL 2 includes the reconstruction patches. The predetermined images are able to be reconstructed from the reconstruction patches on the basis of continuity between reconstruction patches because the reconstruction patches are generated by dividing the predetermined images into reconstruction patches. When the predetermined images are face images, the face images are able to be reconstructed from the reconstruction patches in the database.

In the image processing apparatus according to the technology of PTL 3, the combinations of middle-frequency patches and high-frequency patches are accumulated in a dictionary. The high-frequency images are able to be reconstructed from high-frequency patches on the basis of continuity between high-frequency patches. The high-frequency images are high-frequency components which represent edges, outlines, contours and the like. Therefore, when the input images are face images, faces are able to be recognized in the high-frequency images.

The image generation apparatus of PTL 4 does not need to include a database including some images. When face images are used for the source images for the image generation apparatus of PTL 4, faces of the face images are able to be recognized in at least a part of the morphing images output by the image generation apparatus.

A database according to the technology of NPL 1 includes a large number of high-resolution face images themselves.

Accordingly, the technologies according to PTL 1 to 4 and NPL 1 are not able to enhance privacy in database.

One of the object of the present invention is to provide an image processing technology capable of enhancing privacy in database.

### Solution to Problem

An information processing device according to an exemplary aspect of the present invention includes: basis synthesis means for generating bases and first coefficient sets from first data, the bases with each of the first coefficient sets representing a piece of the first data; and data synthesis means for determining a second coefficient set based on the first coefficient sets, the second coefficient set being different from the first coefficient sets, and synthesizing second data by using the bases and the second coefficient set.

An information processing method according to an exemplary aspect of the present invention includes: generating bases and first coefficient sets from first data, the bases with each of the first coefficient sets representing a piece of the first data; and determining a second coefficient set based on the first coefficient sets, the second coefficient set being different from the first coefficient sets, and synthesizing second data by using the bases and the second coefficient set.

A storage medium storing a program according to an exemplary aspect of the present invention causes a computer to operate: basis synthesis processing of generating bases and first coefficient sets from first data, the bases with each of the first coefficient sets representing a piece of the first data; and data synthesis processing of determining a second coefficient set based on the first coefficient sets, the second coefficient set being different from the first coefficient sets, and synthesizing second data by using the bases and the second coefficient set.

### Advantageous Effects of Invention

The present invention is capable of enhancing privacy in database.

### BRIEF DESCRIPTION OF DRAWINGS

FIG. 1 is a block diagram representing an example of a structure of an information processing device according to a first example embodiment of the present invention.

FIG. 2 is a block diagram representing elements of the information processing device according to the first example embodiment of the present invention, which operate in a data synthesis phase.

FIG. 3 is a flow chart representing an operation of the information processing device according to the first example embodiment of the present invention in the data synthesis phase.

FIG. 4 is a diagram schematically representing an example of face images and an image representing bases into which the face images are factorized according to NMF.

FIG. 5 is a block diagram representing elements of the information processing device according to the first example embodiment of the present invention, which operate in a high resolution image reconstruction phase.

FIG. 6 is a flow chart representing an example of an operation in the high resolution image reconstruction phase of the information processing device according to the first example embodiment of the present invention.

FIG. 7 is a block diagram showing an example of structure of an information processing device according to a second example embodiment of the present invention.

FIG. 8 is a block diagram representing elements which are in operation when the information processing device according to the second example embodiment is in the data synthesis phase.

FIG. 9 is a flow chart showing an example of an operation in the data synthesis phase of the information processing device according to the second example embodiment of the present invention.

FIG. 10 is a block diagram representing an example of a structure of an information processing device according to a third example embodiment of the present invention.

FIG. 11 is a flow chart representing an example of an operation of the information processing device according to the third example embodiment of the present invention.

FIG. 12 is a block diagram representing an example of a hardware structure of a computer which is able to be used for achieving the information processing device according to any one of the example embodiments of the present invention.

### DESCRIPTION OF EMBODIMENTS

### First Example Embodiment

A first example embodiment of the present invention will be explained in detail with reference to drawings.

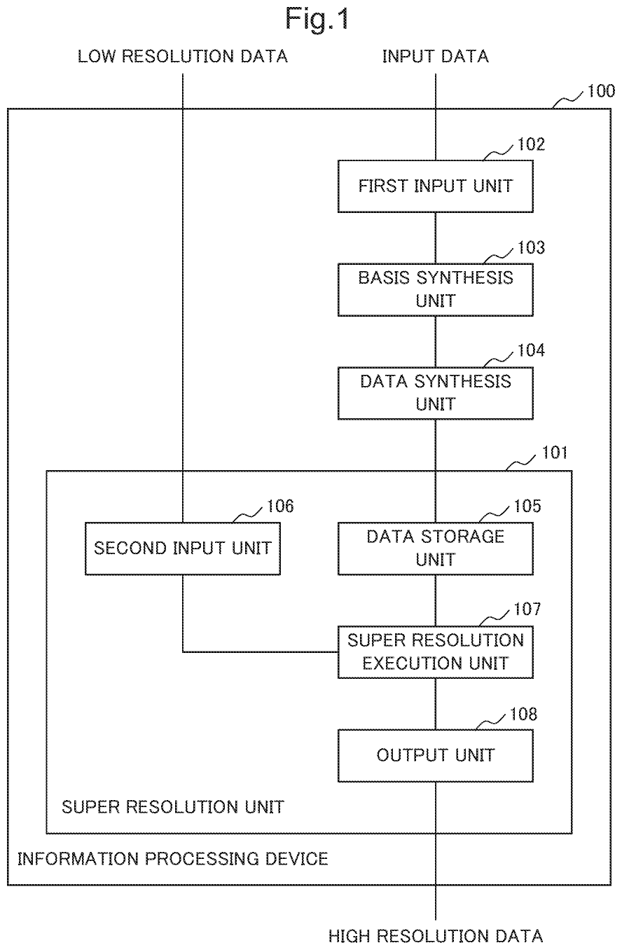

FIG. 1 is a block diagram representing an example of a structure of an information processing device 100 according to the first example embodiment of the present invention.

The information processing device 100 includes a super resolution unit 101, a first input unit 102, a basis synthesis unit 103, and a data synthesis unit 104. The super resolution unit 101 includes a data storage unit 105, a second input unit 106, a super resolution execution unit 107 and an output unit 108. The data storage unit 105 may be also referred to as a dictionary 105.

First, an outline of the super resolution unit 101 is described. The super resolution unit 101 may receive dictionary data including data pairs, e.g. image pairs from the data synthesis unit 104, and may store the received dictionary data. Each of the data pairs includes low resolution dictionary data (hereinafter, also referred to as low resolution data) and high resolution dictionary data (hereinafter, also referred to as high resolution data) of the low resolution dictionary data. The low resolution data and the high resolution data included in a pair represent the same thing or the same person. The low resolution data is data whose resolution is lower than that of the high resolution data. The low resolution data and the high resolution data may be images, e.g. face images. In this case, a piece of the low resolution data may be referred to as a low resolution image and as a low resolution face image. A piece of the high resolution data may be referred to as a high resolution image and as a high resolution face image. The super resolution unit 101 receives a low resolution image for which an image with high resolution is not obtained. The low resolution image received by the super resolution unit 101, for which an image with high resolution is not obtained, is referred to as a query image. The super resolution unit 101 reconstructs a high resolution image from the low resolution input image (such as a low resolution face image) on the basis of the dictionary data. The high resolution image reconstructed by the super resolution unit 101 is also referred to as a high resolution reconstruction image. The super resolution unit 101 is described in detail later.

The first input unit 102 receives input data from, for example, a server or a terminal device. The input data may be images, e.g. face images. In such a case, the input data may be referred to as input images and input face images. The input data represents information on objects or persons that actually exist. For example, the input images are images of objects or persons that actually exist. The face images represent faces of persons who actually exist. Though the following description mainly describes a case where the input data are images, the input data are not limited to images.

The input images received by the first input unit 102 are used for generating dictionary images for a database in the information processing device 100. For example, in a case where the information processing device 100 is configured to reconstruct super-resolution face images, the first input unit 102 receives, as dictionary images, face images of persons who actually exist.

The basis synthesis unit 103 generates bases with coefficient sets from the input data by a factorization method. As described below, a coefficient set is a set of coefficients each assigned to the bases, and each coefficient set in the coefficient sets, together with the bases, represents a piece of the input data, e.g. an image. For example, the basis synthesis unit 103 factorizes the input data, e.g. the input images, received by the first input unit 102, into bases and coefficients based on Non-negative Matrix Factorization (NMF). In a case where the information processing device 100 is used in order to obtain a high resolution image or a super resolution image of a face image, the basis synthesis unit 103 factorizes the input images, which are face images, into bases and coefficients by NMF. The bases generated according to NMF may be referred to as NMF bases. In a case where the input data are face images, different NMF bases may represent different facial parts.

First, the basis synthesis unit 103 may generate a matrix representing the input data, e.g. input images. The matrix representing the input images is referred to as an input data matrix. An example of the input data matrix is represented in Math. 1. In Math. 1, a matrix P is the input data matrix. The column vectors p₁ to p_{M} correspond to elements in the first to the M-th columns of the matrix P, respectively. The input images are represented by vectors p₁ to p_{M}. Each of the vectors p₁ to pₘ represents one of the input images used for the input data matrix P. The basis synthesis unit 103 may convert each of the input images into one of the vectors p₁ to p_{M} so that an element of a vector in the vectors p₁ to p_{M} represents a pixel value of an input image in the input images. The scalar M represents the number of the vectors p₁ to p_{M}, that is, the number of input images used for the input data matrix P. Each of the pixel values of the input images are equal to or larger than zero, i.e. non-negative. Therefore, each of the elements of the matrix P is equal to or larger than zero. In other words, the matrix P is non-negative matrix. The number of elements of each of the vectors p₁ to pₘ is represented by a scalar K in the following description. In other words, the matrix P is a K×M matrix, and each of the vectors p₁ to p_{M} is a K-dimensional vector. The vectors p₁ to p_{M} are also referred to as sample vectors in the following description.

P={p₁ p₂ . . . p_{M}} [Math. 1]

Next, the basis synthesis unit 103 may factorize the input data matrix P into two non-negative matrices by using an existing method of NMF. The equation of Math. 2 represents the factorization of the input data matrix P into two non-negative matrices F and A. In the following description, the matrix F is a K×N matrix, and the matrix A is an N×M matrix. The scalar N represents the number of bases, and may be determined in advance by a user of the information processing device 100.

P=FA [Math. 2]

The matrix F is represented by N column vectors Φ₁ to Φ_{N} as Math. 3. Each of the vectors Φ₁ to Φ_{N} represents elements in a column of the matrix F. The number of elements of each of the vectors Φ₁ to Φ_{N} is K.

F={Φ₁ Φ₂ . . . Φ_{N}} [Math. 3]

The K-dimensional vectors Φ₁ to Φ_{N} are the bases, i.e. the basis vectors according to NMF, of the input images. As described above, the basis synthesis unit 103 factorizes a matrix generated using the sample vectors p₁ to p_{M} each representing the input images into the basis vectors Φ₁ to Φ_{N} with coefficients. As a result, the sample vectors p₁ to p_{M} are represented by the equation of Math. 4.

$${p}_{m =} {\sum }_{n} {a}_{nm} {Φ}_{n} , m = 1 , ⋯ , M \qquad [ Math . 4 ]$$

In the equation of Math. 4, the scalar aₙₘ is the (n, m) element of the matrix A of Math. 2. The scalar (e.g. aₙₘ) assigned to a basis (e.g. a basis vector Φₙ) to represent a sample (e.g. a sample vector pₘ) is also referred to as a combination coefficient and also simply as a coefficient. The set of combination coefficients (e.g. {a₁ₘ, . . . , a_{Nm}}) to represent one sample (e.g. a sample vector pₘ or the like) is referred to as a combination coefficient set and also simply as a coefficient set.

The data synthesis unit 104 may generate combination coefficient sets each of which is different from any of the combination coefficient sets of the sample vectors p₁ to p_{M}. The number of the combination coefficient sets generated by the data synthesis unit 104 may be determined in advance. The data synthesis unit 104 may generate new data using the combination coefficient set which are generated and the bases (e.g. the basis vectors Φₙ (n=1, . . . , N)). The data synthesis unit 104 stores the new data that is generated in the data storage unit 105. The new data generated by the data synthesis unit 104 is referred to as synthesized data.

The data synthesis unit 104 may generate low resolution data from the generated new data, i.e. from the synthesized data. The method of generating the low resolution data may be one of existing methods generating low resolution data. The data synthesis unit 104 may associate the low resolution data with the new data from which the low resolution data is generated.

When the new data generated by the data synthesis unit 104 are images, the data synthesis unit 104 may further generate low resolution images of the generated images by sampling, smoothing, or the like. The images from which the low resolution images are generated are referred to as high resolution images. When the images are face images, the images are referred to as high resolution face images, and the low resolution images are referred to as low resolution face images. The data synthesis unit 104 may associate the generated low resolution images with the image from which the low resolution images are generated. The data synthesis unit 104 may store, in the data storage unit 105, the generated low resolution images each being associated with the images from which the low resolution images are generated.

More specifically, the data synthesis unit 104 generates, on the basis of the combination coefficient sets of the input images (i.e. the sample vectors p₁ to p_{M}), a combination coefficient set which is different from the combination coefficient sets of the sample vectors p₁ to p_{M}. The data synthesis unit 104 may repeat generation of a combination coefficient set until a predetermined number of different combination coefficient sets are generated.

The data synthesis unit 104 may randomly select a combination coefficient for a basis vector Φₙ (where n is included in a set of natural numbers {1, . . . , N}) from among the combination coefficients aₙₘ (m=1, . . . , M) calculated for the sample vectors p₁ to pₘ as the coefficients of the basis vector Φₙ.

The data synthesis unit 104 may select one combination coefficient for each of the basis vectors as an element of a combination coefficient set. The data synthesis unit 104 may determine a set of the combination coefficients each selected for the basis vectors as the combination coefficient set. When the set of the combination coefficients each selected for the basis vectors is the same as any of the combination coefficient sets calculated for the sample vectors p₁ to p_{M}, the data synthesis unit 104 may abandon the set of the combination coefficients selected, and may select the combination coefficients for the basis vectors again.

When the number of the combination coefficient sets to be generated is equal to or smaller than the number of dictionary images (i.e. the sample vectors), the data synthesis unit 104 may generate the combination coefficient sets with allowing any of the combination coefficients to be selected at most once. When the number of the combination coefficient sets to be generated is equal to or larger than the number of dictionary images (i.e. the sample vectors), the data synthesis unit 104 may generate the combination coefficient sets with allowing any of the combination coefficients to be selected at least once. The data synthesis unit 104 may generate the combination coefficient sets so that, for each of the sample vectors, at least one of the coefficients, together with the bases, representing a sample vector is not selected.

The data synthesis unit 104 may determine a combination coefficient set of the basis vectors Φₙ according to a rule determined so that the determined combination coefficient set does not become the same as any of the combination coefficient sets that are calculated for the sample vectors p₁ to p_{M}.

The data synthesis unit 104 may determine a distribution range of the combination coefficients of a basis vectors Φₙ, which are calculated for the sample vectors p₁ to p_{M}. The data synthesis unit 104 may randomly determine a combination coefficient for the basis vector Φₙ so that the combination coefficient to be determined is included within the determined distribution range of the calculated combination coefficients of the basis vector Φₙ.

The data synthesis unit 104 may select a combination coefficient for a basis vector pₘ from the combination coefficients aₙₘ calculated for the basis vector pₘ with allowing any of the combination coefficients to be selected more than once.

The data synthesis unit 104 synthesizes data, e.g. images, by using the bases and the combination coefficient sets that are generated. The images synthesized by the data synthesis unit 104 may be face images.

The data synthesis unit 104 may combine the bases by using a combination coefficient set of the combination coefficient sets into a piece of synthesized data. More specifically, the data synthesis unit 104 may select a combination coefficient set from the combination coefficient sets, and sum up products each of which is calculated by multiplying a combination coefficient of the combination coefficient set and the basis to which the combination coefficient is assigned, and set the summation of the products as a piece of synthesized data, e.g. an image. The data synthesis unit 104 may repeat combining the bases for each of the combination coefficient sets.

Math.5 represents an example of pieces of the synthesized data, e.g. synthesized images. The synthesized images may be face images. In Math. 5, the vector bₛ (where s=1, . . . , S) represents pieces of the synthesized data. The scalar S represents the number of the pieces of the synthesized data, e.g. the number of the synthesized images. The scalar a_{nr(n,s)} represents the combination coefficient of the basis vector Φₙ, which is selected from among the combination coefficients of the basis vector Φₙ, which are calculated for the sample vectors p₁ to p_{M}, as the combination coefficient of the basis vector Φₙ for the vector bₛ to be synthesized. The scalar a_{nr(n,s)} is a combination coefficient randomly selected for the s-th piece of the synthesized data as a combination coefficient of the basis vector Φₙ from among the combination coefficients of the basis vector Φₙ for the sample vectors p₁ to p_{M}. The scalar r(n,s) indicates the sample vector whose combination coefficient of the basis vector Φₙ is selected. When the combination coefficient of the basis vector Φₙ for the sample vector pₘ₀ (where m0 is a scalar included in the set {1, . . . , M}) is selected as the combination coefficient of the basis vector Φₙ for the vector bₛ to be synthesized, the scalar r(n,s) is equal to m0.

$${b}_{s} = {\sum }_{n} {a}_{nr ( n , s )} {Φ}_{n} , r ( n , s ) ∈ \{ 1 , ⋯ , M \} , s = 1 , ⋯ , S \qquad [ Math . 5 ]$$

Math. 6 represents another example of pieces of the synthesized data, e.g. synthesized images. In the equation of Math. 6, the vector bₛ (where s=1, . . . , S) represents the pieces of the synthesized data. The scalar S represents the number of pieces of the synthesized data, e.g. the number of the synthesized images. The scalar aₙₛ represents the combination coefficient of the basis vector Φ₁ₙ. The scalar aₙₛ is randomly determined so that the scalar aₙₛ is included in a range from the minimum of the scalars aₙₘ (m=1, . . . , M) to the maximum of the scalars aₙₘ (m=1, . . . , M). The scalars aₙₘ (m=1, . . . , M) is a combination coefficients of the basis vector Φₙ calculated for the sample vectors p₁ to p_{M}.

$${b}_{s} = {\sum }_{n} {a}_{n , s} {Φ}_{n} , {a}_{ns} ∈ [ {min}_{m} ( {a}_{nm} ) , {max}_{m} ( {a}_{nm} ) ] , \\ s = 1 , ⋯ , S \qquad [ Math . 6 ]$$

Each of the generated combination coefficient sets is different from any of the combination coefficient sets calculated for the sample vectors p₁ to p_{M}, which represent the data received by the first input unit 102. Therefore, synthesized data is different from the data received by the first input unit 102.

The set of the scalars aₙₘ (n=1, . . . , N) in the equation of Math. 4 is the combination coefficient set calculated for the sample vector pₘ. The set of the scalars a_{nr(n,s)} (n=1, . . . , N) in Math. 5 is a generated combination coefficient set of the vector bₛ representing a piece of synthesized data. The set of the scalars aₙₛ (n=1, . . . , N) in Math. 6 is a generated combination coefficient set of the vector bₛ representing a piece of synthesized data.

In a case where the data to be synthesized are face images, each of the synthesized face images is different from any of the face images received by the first input unit 102. The faces of the face images that are synthesized are not the faces of the face images received by the first input unit 102, i.e. faces of persons who actually exist. In other words, the faces of the synthesized face images are not any of the faces of persons who actually exist and whose face images are provided to the information processing device 100 as the input images.

The data synthesis unit 104 stores the synthesized data in the data storage unit 105. In a case where the synthesized data are synthesized face images, the data synthesis unit 104 stores the synthesized face images in the data storage unit 105. The faces represented by the face images synthesized by the data synthesis unit 104 do not correspond to any of the faces represented by the face images received by the first input unit 102 as the dictionary images.

When the synthesized data are images, the data synthesis unit 104 may generate partial images of the images (i.e. the high resolution images, e.g. face images). The partial images of the high resolution images are hereinafter referred to as reconstruction patches. The reconstruction patches may overlap with other reconstruction patches. In other words, areas, in the high resolution image, from which the reconstruction patches are extracted may overlap with areas from which other reconstruction patches are extracted. The data synthesis unit 104 may generate partial images of the low resolution images. The partial images of the low resolution images are hereinafter referred to as degradation patches. The data synthesis unit 104 may generate the degradation patches so that each of the degradation patches is a degraded image of one of the reconstruction patches, that is, each of the degradation patches corresponds to one of the reconstruction patches. The data synthesis unit 104 may store patch pairs, each of which is a pair of a reconstruction patch and a degradation patch that corresponds to the reconstruction patch. The degradation patch that corresponds to a reconstruction patch is, for example, a degraded image of the reconstruction patch.

The data storage unit (dictionary) 105 stores, as dictionary data, the synthesized data generated by the data synthesis unit 104 and the low resolution data of the synthesized data. The dictionary data is the synthesized data and the low resolution data of the synthesized data. The dictionary data is used for generating super-resolution data of a low resolution input query data obtained by the second input unit 106. The low resolution input query data (also referred to simply as query data) is data received by the second input unit 106 as described below. The resolution of the low resolution input query data may be lower than that of the synthesized data. In a case where the dictionary data are face images, synthesized face images representing faces that are not faces of persons who actually exist are used as the dictionary data for generating super-resolution data instead of face images representing faces of persons who actually exist. The synthesized data and the low resolution data (e.g. the high resolution face images (also referred to as high resolution face images) and low resolution face images) are stored in the data storage unit (dictionary) 105 in a manner in which the synthesized data is paired with the low resolution data. For example, a synthesized face image (i.e. high resolution face image) is paired with a low resolution face image that is an image of a face represented by the synthesized face image paired with the low resolution face image.

When the synthesized data are images (e.g. face images), the data storage unit 105 may store the reconstruction patches and the degradation patches as the synthesized data and the low resolution data.

The second input unit 106 receives query data (i.e. the low resolution input query data described above) which is of low resolution data (such as a low resolution face image) from a user terminal or the like. The low resolution data received by the second input unit 106 is referred to as the query data. In a case where the low resolution data received by the second input unit 106 is an image, the low resolution data received by the second input unit 106 may be referred to as a query image. When the query image is a face image, the query image may be referred to as a query face image.

The super resolution execution unit 107 reconstructs high resolution data from the query data received by the second input unit 106, by using pairs of low resolution data and high resolution data stored in the data storage unit 105. The super resolution execution unit 107 may reconstruct high resolution data from the query data on the basis of an exemplar based super resolution technology.

More specifically, when the query data is an image, the super resolution execution unit 107 may generate partial images of the query image, i.e. the query data. The partial images of the query image are referred to as query patches. The query patches may overlap with other query patches. The super resolution execution unit 107 may select a degradation patch for each of the query patches on the basis of similarity between the degradation patches and the query patches. For example, the super resolution execution unit 107 may select, for a query patch, the degradation patch having highest similarity to the query patch. The super resolution execution unit 107 may repeat selection of a degradation patch for each of the query patches. The super resolution execution unit 107 may synthesize, as the high resolution data, a high resolution image from reconstruction patches corresponding to the degradation patches selected for the query patches. For example, the super resolution execution unit 107 may arrange the reconstruction patches according to positions, in the query image, of the query patches for which the degradation patches corresponding to the reconstruction patch are selected. The super resolution execution unit 107 may generate, as the high resolution data, a high resolution image from the arranged reconstruction patches by interpolation or the like.

The output unit 108 outputs the high resolution data reconstructed by the super resolution execution unit 107. If the high resolution data is an image, the output unit 108 outputs the high resolution image as the high resolution data.

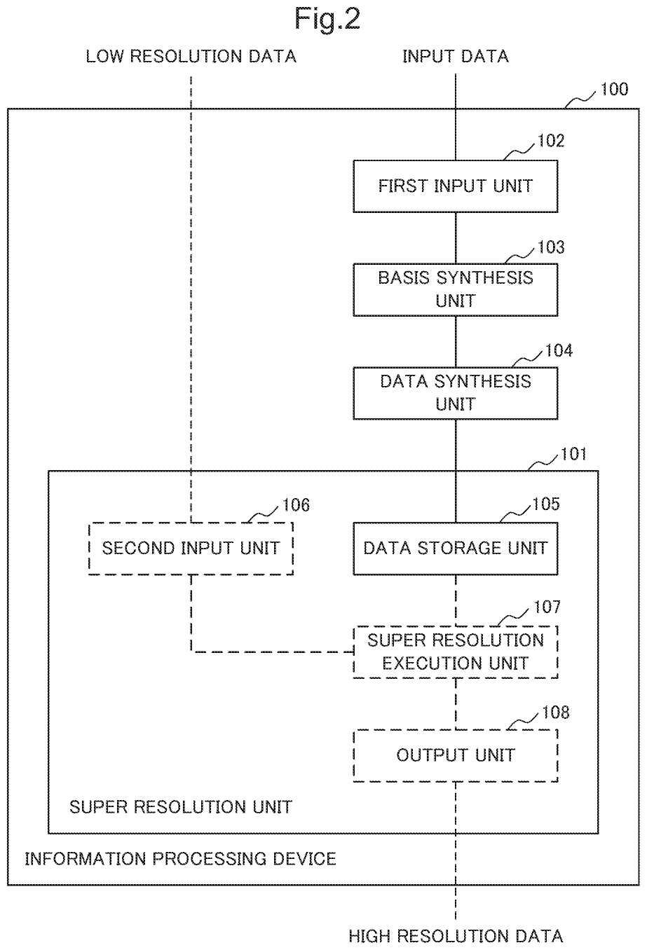

FIG. 2 is a block diagram representing elements of the information processing device 100 according to the first example embodiment of the present invention, which operate in a data synthesis phase. In FIG. 2, the elements that operate in the data synthesis phase is drawn by solid lines. The elements that do not operate in the data synthesis phase is drawn by broken lines.

In the data synthesis phase, the first input unit 102, the basis synthesis unit 103, the data synthesis unit 104 and the data storage unit 105 operate. The other units are drawn by broken lines.

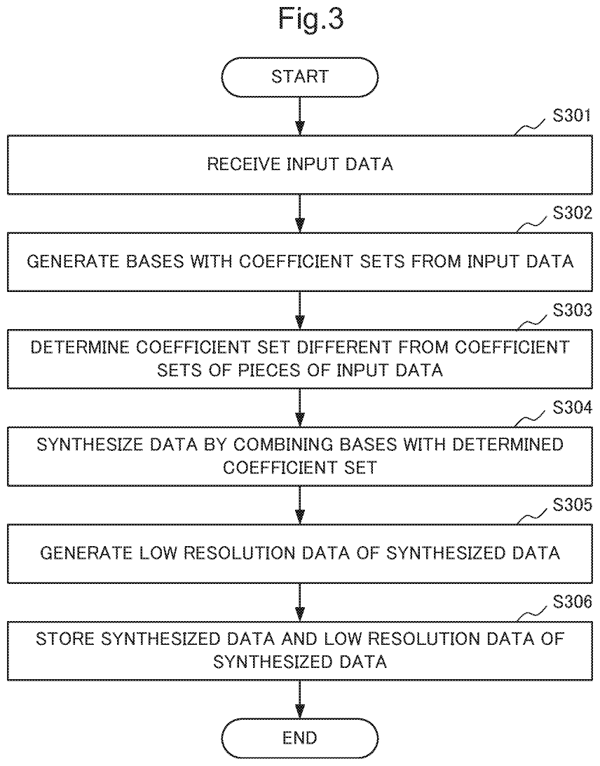

FIG. 3 is a flow chart representing an operation of the information processing device 100 according to the present example embodiment of the present invention in the data synthesis phase.

Referring to FIG. 3, the first input unit 102 receives input data, i.e. the input data described above (Step S301). The input data may include information on a person that actually exists. The information on a person may include privacy information, such as, face information or other biometrics information. As described above, the input data may be face images.

The basis synthesis unit 103 generates bases with coefficients from the input data received in Step S301 (Step S302). More specifically, the basis synthesis unit 103 factorizes the input data received in Step S301 into bases with coefficients. The basis synthesis unit 103 may factorize a matrix representing the input data into a matrix representing bases and a matrix representing coefficients according to NMF. In a case where the input data are face images, the bases into which the input data is factorized according to NMF may represent facial parts.

The data synthesis unit 104 determines coefficients for each of the bases obtained in Step S302 (Step S303) so that a set the determined coefficients is different from any set of coefficients calculated from a piece of the input data in Step S302.

The set of coefficients, referred to as a coefficient set as described above, is a set of coefficients each assigned to the bases. More specifically, each of the coefficient in the set of coefficients is assigned to one of the bases, and any two of the coefficients in the set of coefficients are not assigned to the same basis. The set of coefficients, together with the bases obtained in Step S302, represents a piece of data which can be factorized into the bases. The above-described set of coefficients, together with the bases, represents, for example, a piece of input data, synthesized data, or the like. More specifically, a piece of the input data, synthesized data, or the like is represented by linear combination of the coefficients in the set and the bases as in the equation of Math. 4. The piece of input data, synthesized data, or the like may be an image, e.g. a face image. The set of coefficients, i.e. the coefficient set, calculated for a piece of input data may be represented by elements of a column of the matrix A in the equation of Math. 2.

The data synthesis unit 104 may randomly select a coefficient of a basis from among coefficients of the basis calculated for pieces of input data. The piece of data, e.g. the input data, may be a face image. The data synthesis unit 104 may randomly select a coefficient of a basis from among the coefficients of the basis calculated for the face images which are received as the input data. The data synthesis unit 104 may repeat random selection of a coefficient for each of the bases obtained in Step S302. As described above, the data synthesis unit 104 may select coefficients in other method.

The data synthesis unit 104 synthesizes data by combining the bases with the determined coefficients (Step S304). In other words, the data synthesis unit 104 combines the bases with the determined coefficients by, for example, linear combination into synthesized data. The set of the determined coefficients is different from any of the sets of the coefficients calculated for the pieces of the input data. Therefore, the synthesized data is different from any piece of the input data. Information represented by the synthesized data is different from information represented by the input data. When the synthesized data and the input data are images, an object, a person or the like represented by an image of the synthesized data is not any of objects, persons or the like which actually exist and are represented by the images represented by the input data. In a case where the input data and the synthesized data are face images, the bases, which may represent different facial parts, are combined with the coefficients, which may be selected randomly, into a face image. The synthesized face image, i.e. the face image into which the bases and selected coefficients are combined, represents a face that is different from any of the faces represented by the face images that is the input image. In other words, the synthesized face image represents a face which does not actually exist.

The data synthesis unit 104 generates low resolution data of the synthesized data (Step S305). When the synthesized data and the low resolution data are images, e.g. face images, the data synthesis unit 104 may generate the reconstruction patches from the synthesized data, i.e. the synthesized images. The data synthesis unit 104 may further generate the degradation patches (which may be also referred to as low resolution patches) from the reconstruction patches.

The data synthesis unit 104 stores the synthesized data and the low resolution data of the synthesized data in the data storage unit 105 (Step S306). The synthesized data and the low resolution data which are stored in the data storage unit 105 are to be used as the dictionary data by the super resolution execution unit 107. In a case where the synthesized data and the low resolution data are images, the data synthesis unit 104 may store the reconstruction patches generated from the synthesized image and the degradation patches generated from the low resolution image of the synthesized image in the data storage unit 105.

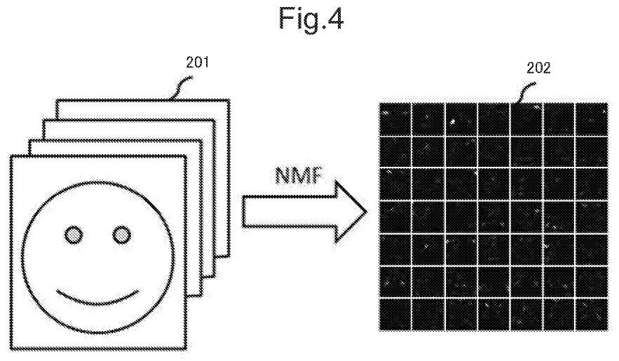

FIG. 4 is a diagram schematically representing an example of face images and an image representing bases into which the face images are factorized by the basis synthesis unit 103 according to NMF. As described above, each of the bases may represent a facial part of a face. The images 201 are the face images which are factorized. The image 202 represents an image into which images representing the bases are combined.

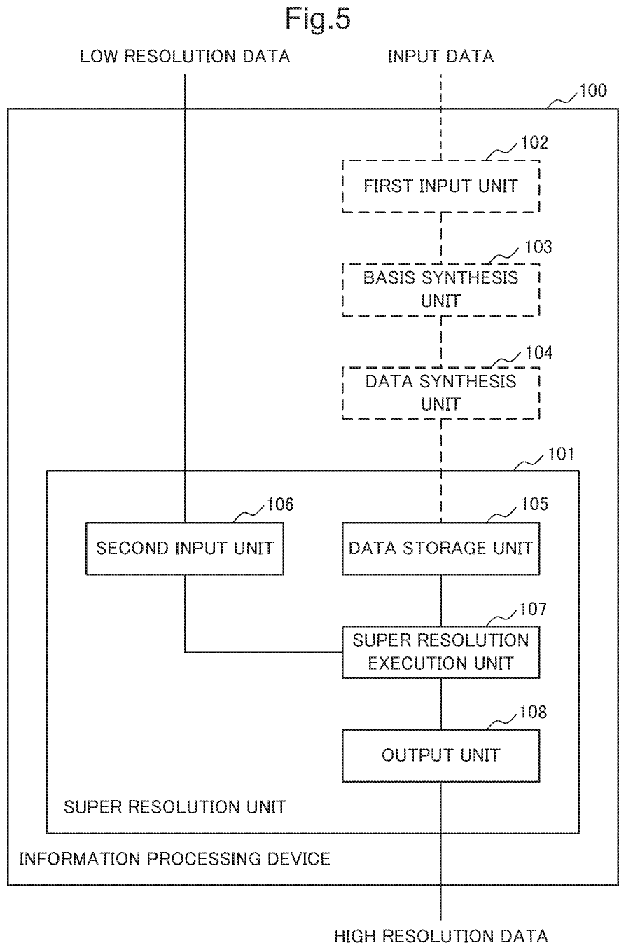

FIG. 5 is a block diagram representing elements of the information processing device 100 according to the present example embodiment of the present invention, which operate in a high resolution image reconstruction phase. In FIG. 5, elements that operate are drawn by solid lines, and other elements are drawn by broken lines. The high resolution image reconstruction phase represents an operation in a case where the synthesized data, the low resolution data and the query data received by the second input unit 106 are images. In the high resolution image reconstruction phase, a high resolution image is generated from a low resolution image by using the reconstruction patches and the degradation patches on the basis of the exemplar-based super resolution technology. More specifically, the reconstruction image is generated from the reconstruction patches on the basis of similarity between the low resolution image and the degradation patches and relation between the degradation patches and the reconstruction patches.

Referring to FIG. 5, the second input unit 106, the super resolution execution unit 107, and the output unit 108 operate in the high resolution image reconstruction phase.

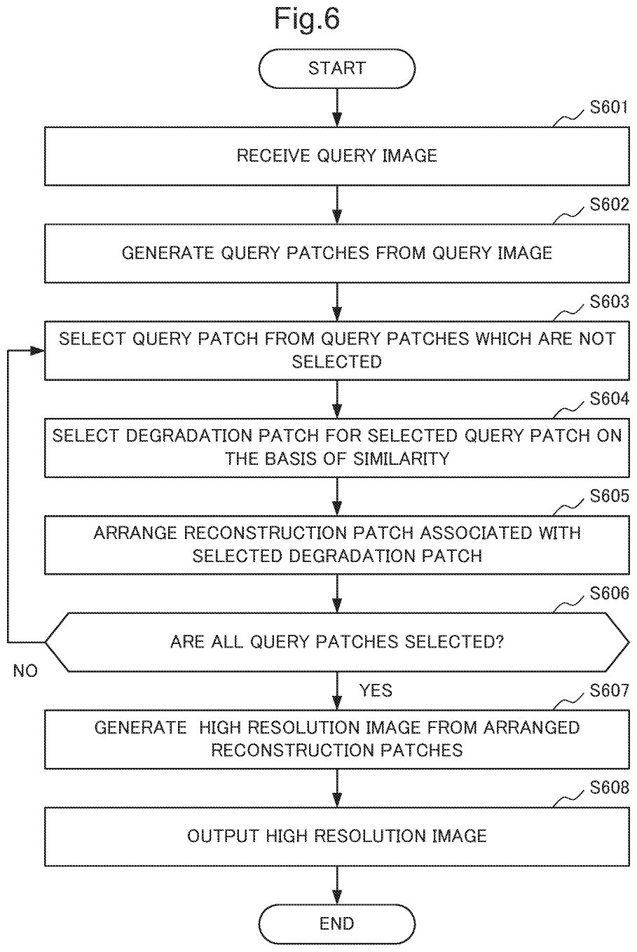

FIG. 6 is a flow chart representing an example of an operation in the high resolution image reconstruction phase of the information processing device 100 according to the present example embodiment of the present invention. In the description of the operation represented by FIG. 6, data received by the second input unit 106 is a low resolution image, i.e. a query image.

The second input unit 106 receives a query image (Step S601). The query image received in Step S601 has lower resolution in comparison with the synthesized image and the input data received by the first input unit 102.

The super resolution execution unit 107 generates query patches from the query images (Step S602). The query patches are partial images of the query image. The super resolution execution unit 107 may divide the query image into query patches. The super resolution execution unit 107 may extract the query patches from the query images so that the areas, in the query image, from which at least two of the query patches are extracted may overlap with each other.

The super resolution execution unit 107 selects a query patch from the generated query patches (Step S603).

The super resolution execution unit 107 selects a degradation patch from the degradation patches stored in the data storage unit 105 for the selected query patch on the basis of similarity between the degradation patches and the selected query patch (Step S604). The super resolution execution unit 107 may select the degradation patch most similar to the selected query patch from the data storage (dictionary) unit 105.

The super resolution execution unit 107 arranges the reconstruction patch associated with the degradation patch selected for the selected query patch on the basis of, for example, the position of the area of the query image from which the query patch is extracted (Step S605). The degradation patch and the reconstruction patch associated with the degradation patch represent the same part of a synthesized image. The reconstruction patch associated with the degradation patch may be the reconstruction patch from which the degradation patch is generated.

When not all the query patch generated from the query image are selected (NO in Step S606), the super resolution execution unit 107 repeats the operation from Step S603 to Step S605.

When all the query patch generated from the query image are selected (YES in Step S606), the super resolution execution unit 107 generates a high resolution image from the arranged reconstruction patches (Step S607). For example, the super resolution execution unit 107 combines the arranged reconstruction patches into a high resolution image. The resolution of the high resolution image is higher than that of the query image.

The output unit 108 output the high resolution image generated by the super resolution execution unit 107 (Step S608).

An advantageous effect of the present example embodiment is that the information processing device 100 according to the present example embodiment is capable of enhancing privacy in database including personal information representing a personal feature, e.g. face images representing faces.

The reason is that the basis synthesis unit 103 generates, from the input data, bases and coefficients, and the data synthesis unit 104 selects, for the bases, a set of coefficients which is different from any of the sets of the coefficients into which the input data is factorized. The data synthesis unit 104 generates synthesized data by combining the bases with the selected coefficients into the synthesized data. The synthesized data generated by the data synthesis unit 104 is different from any piece of the input data. Therefore, even when the input data includes privacy information, e.g. faces, the synthesized data does not represent privacy information included in the input data.

### Second Example Embodiment

A second example embodiment of the present invention will be explained in detail with reference to drawings.

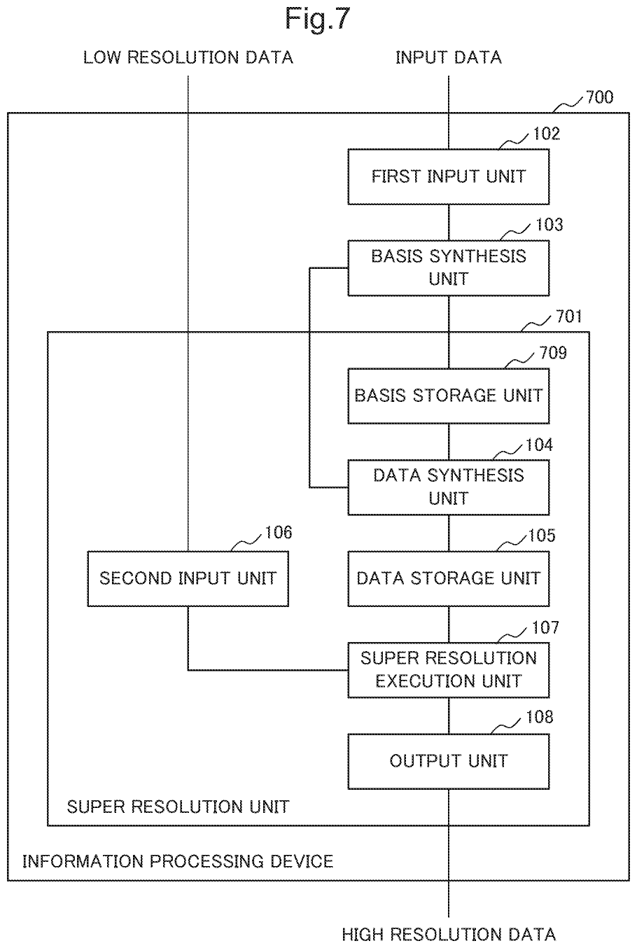

FIG. 7 is a block diagram showing an example of a structure of an information processing device 700 according to the present example embodiment of the present invention.

The information processing device 700 includes the first input unit 102, the basis synthesis unit 103, and a super resolution unit 701. The super resolution unit 701 includes a basis storage unit 709, the data synthesis unit 104, the data storage unit 105, the second input unit 106, the super resolution execution unit 107, and the output unit 108.

The above-described units other than the basis synthesis unit 103 and the basis storage unit 709 are the same as those of the units of the information processing device 100 of the first example embodiment.

The basis synthesis unit 103 of the information processing device 700 according to the present example embodiment operates in the same way as the basis synthesis unit 103 of the information processing device 100 according to the first example embodiment. The basis synthesis unit 103 generates the bases and the coefficients based on the input data.

The basis synthesis unit 103 stores the bases in the basis storage unit 709. The basis synthesis unit 103 may store, in the basis storage unit 709, a matrix representing the bases, which is obtained by, for example, NMF. The matrix representing the bases is represented by the matrix F in the equation of Math. 2. The matrix representing the bases is referred to as a basis matrix in the following description. The basis synthesis unit 103 may store the bases separately in a form of, for example, vectors in the basis storage unit 709. In this case, the vectors correspond to columns of the basis matrix, and are represented by the vectors Φ₁ to Φₙ in the equation of Math. 3.

The basis synthesis unit 103 may provide the coefficients, e.g. the coefficient sets, generated from the input data to the data synthesis unit 104.

The data synthesis unit 104 receives the coefficients, e.g. the coefficient sets. The data synthesis unit 104 may determine coefficient sets different from the received coefficient sets, which are generated from the input image, in the same manner as the data synthesis unit 104 of the first example embodiment. The data synthesis unit 104 may store the determined coefficient sets in the basis storage unit 709. The data synthesis unit 104 may generate high resolution data by using the bases and the coefficient sets stored in the basis storage unit 709.

The basis storage unit 709 stores the bases generated from the input data by the basis synthesis unit 103. The basis storage unit 709 may further store the coefficients determined by the data synthesis unit 104.

Except for the above-described differences, the information processing device 700 is the same as the information processing device 100 according to the first example embodiment.

Next, an example of an operation of the information processing device 700 according to the present example embodiment will be described.

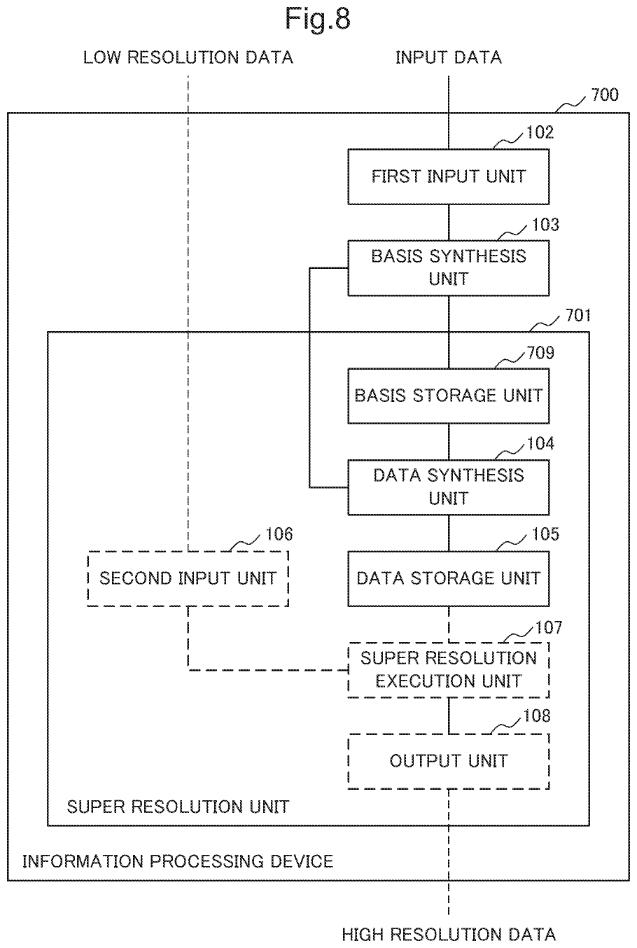

FIG. 8 is a block diagram representing elements which are in operation when the information processing device 700 is in the data synthesis phase. In FIG. 8, elements which operate in the data synthesis phase are drawn by solid lines, and other elements are drawn in broken lines. In the data synthesis phase, the first input unit 102, the basis synthesis unit 103, the basis storage unit 709, the data synthesis unit 104, and the data storage unit 105 are in operation.

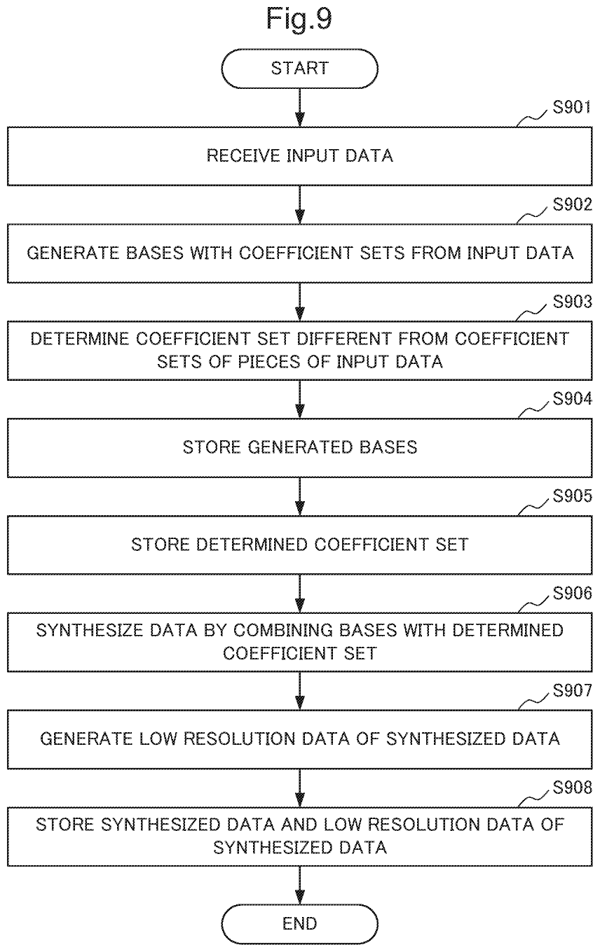

FIG. 9 is a flow chart showing an example of an operation, in the data synthesis phase, of the information processing device 700.

The first input unit 102 receives input data (Step S901). The operation of Step S901 is the same as that of Step S301 in FIG. 3.

The basis synthesis unit 103 generates the bases with the coefficient sets from the input data (Step S902) in the same way as the operation of Step S302 in FIG. 3. The basis synthesis unit 103 may provide the coefficient sets to the data synthesis unit 104.

The data synthesis unit 104 determines a coefficient set different from the coefficient sets of pieces of the input data (Step S903) in the same way as the operation of Step S303 in FIG. 3.

The basis synthesis unit 103 stores the bases in the basis storage unit 709 (Step S904). The operation of Step S904 may be performed before the operation of Step S903.

The data synthesis unit 104 stores the determined coefficient set in the basis storage unit 709 (Step S905). The operation of Step S905 is performed after the operation of Step S903. The operation of Step S905 may be performed before the operation of Step S904.

The data synthesis unit 104 synthesizes data by combining the bases with the determined coefficient set which are stored in the basis storage unit 709 (Step S906).

The data synthesis unit 104 may generate the low resolution data of the synthesize data (Step S907). In a case where the synthesized data is an image, the data synthesis unit 104 may generate reconstruction patches from the synthesized image. The data synthesis unit 104 may generate degradation patches from the reconstruction patches. The data synthesis unit 104 may generate degradation patches from the synthesized image.

The data synthesis unit 104 stores the synthesized data and the low resolution data of the synthesized data in the data storage unit 105 (Step S908). The data synthesis unit may store the reconstruction patches and the degradation patches in the data storage unit 105 as the synthesized data and the low resolution data.

FIG. 6 is a flowchart representing an example of an operation, in the high resolution image generation phase, of the information processing device 700 according to the present example embodiment. In the high resolution image generation phase, the information processing device 700 operates in the same way as the information processing device 100.

The present example embodiment has the same advantageous effect as that of the first example embodiment. The reason why the advantageous effect of the present example embodiment arises is the same as that of the first example embodiment.

### Third Example Embodiment

A third example embodiment of the present invention will be described next.

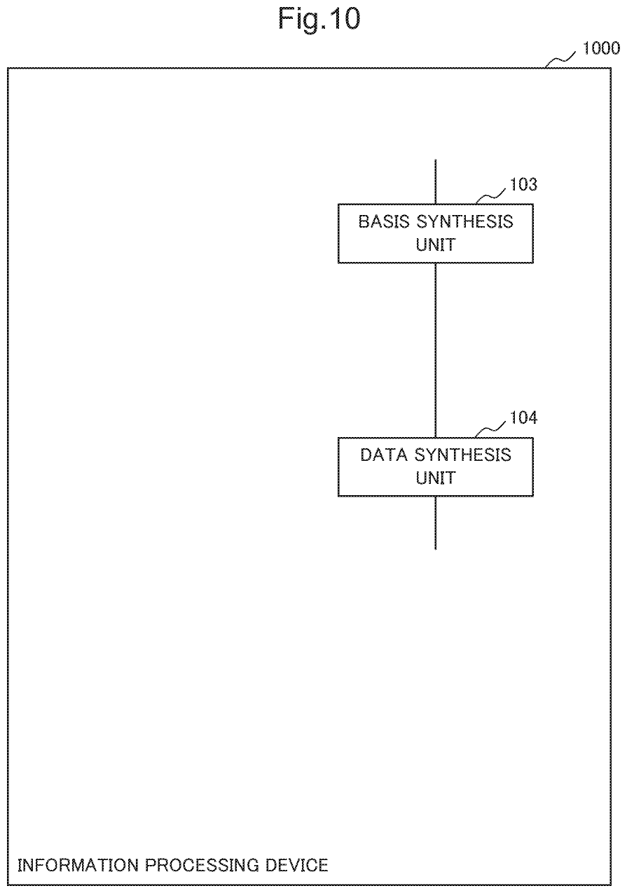

FIG. 10 is a block diagram representing an example of a structure of an information processing device 1000 according to the present example embodiment.

The information processing device 1000 includes the basis synthesis unit 103 and data synthesis unit 104.

The basis synthesis unit 103 generates bases and coefficient sets from the input data. Each of the coefficient sets is a set of coefficients each assigned to the bases. The coefficient sets are, hereinafter, referred to as first coefficient sets. The input data may be represented by a matrix. Each of the bases may be represented by a vector. The basis synthesis unit 103 may generate the bases and the coefficient set by NMF. The bases and each of the first coefficient sets represent a piece of the first data. The piece of the first data may be an image, e.g. a face image.

The data synthesis unit 104 determines a new coefficient set based on the first coefficient sets. The new coefficient set is, hereinafter, referred to as a second coefficient set. The second coefficient set is different from each of the first coefficient sets. In other words, the second coefficient set does not share at least one coefficient with each of the first coefficient sets. The data synthesis unit 104 may randomly select a coefficient assigned to a basis in the bases in the second coefficient set from coefficients assigned to the basis in the first coefficient sets.

The data synthesis unit 104 synthesizes a piece of data using the bases and the second coefficient set. The data synthesis unit 104 calculates linear combination of the bases and the coefficients of the second coefficient set.

Next, an example of an operation of the information processing device 1000 according to the present example embodiment.

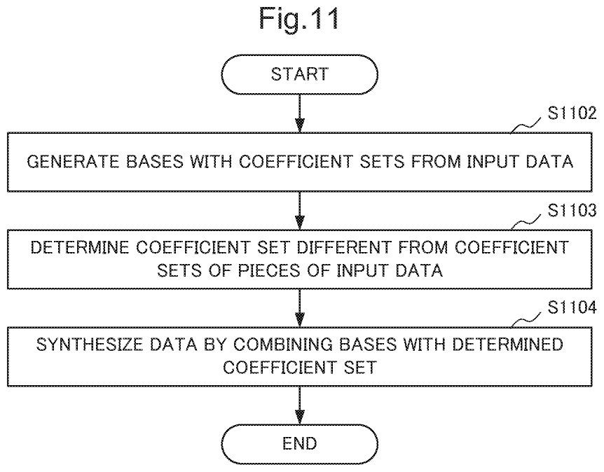

FIG. 11 is a flow chart representing an example of an operation of the information processing device 1000. The basis synthesis unit 103 generates bases with coefficient sets from input data (Step S1102). The data synthesis unit 104 determines a new coefficient set from the coefficient sets of pieces of the input data (Step S1103). The data synthesis unit 104 synthesizes data by combining the bases with determined coefficient set, i.e. the new coefficient set determined (Step S1104).

The present example embodiment has the same advantageous effect as that of the first example embodiment. The reason why the advantageous effect of the present example embodiment arises is the same as that of the first example embodiment.

### Other Example Embodiment

Each of the information processing device 100, the information processing device 700, and the information processing device 1000 can be achieved using dedicated hardware, a computer including a memory and a processor executing a program loaded in the memory, or a combination of dedicated hardware and a computer which includes a memory and a processor executing a program loaded in the memory.

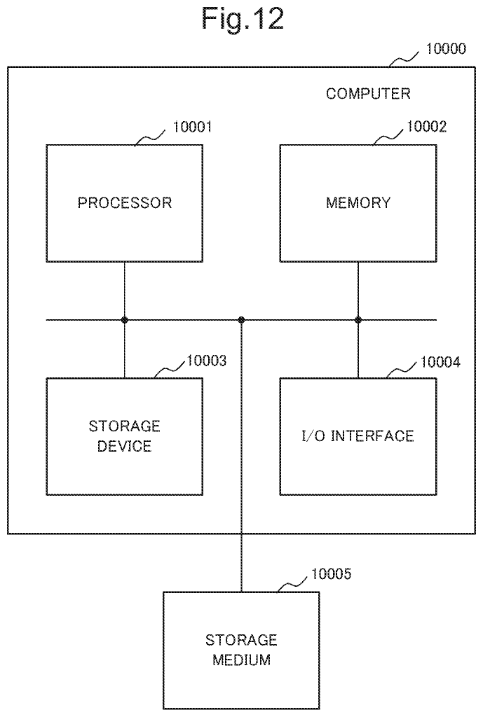

FIG. 12 is a block diagram representing an example of a hardware structure of a computer 10000 which is able to be used for achieving the information processing device 100, the information processing device 700, and the information processing device 1000. As illustrated in FIG. 12, the computer 10000 includes a processor 10001, a memory 10002, a storage device 10003 and an I/O (Input/Output) interface 10004. The computer 10000 can access a storage medium 10005. Each of the memory 10002 and the storage device 10003 may be a storage device, such as a RAM (Random Access Memory), a hard disk drive or the like. The storage medium 10005 may be a RAM, a storage device such as a hard disk drive or the like, a ROM (Read Only Memory), or a portable storage medium. The storage device 10003 may operate as the storage medium 10005. The processor 10001 can read data and a program from the memory 10002 and the storage device 10003, and can write data and a program in the memory 10002 and the storage device 10003. The processor 10001 can communicate with a terminal device (not illustrated) and the like over the I/O interface 10004. The processor 10001 can access the storage medium 10005. The storage medium 10005 stores a program that causes the computer 10000 to operate as one of the information processing device 100, the information processing device 700, and the information processing device 1000.

The processor 10001 loads the program, which causes the computer 10000 operates as one of the information processing device 100, the information processing device 700, and the information processing device 1000, stored in the storage medium 10005 into the memory 10002. The computer 10000 operates as one of the information processing device 100, the information processing device 700, and the information processing device 1000 by the processor 10001 executing the program loaded in the memory 10002.

In the following description, a group of the super resolution unit 101, the first input unit 102, the basis synthesis unit 103, data synthesis unit 104, the second input unit 106, the super resolution execution unit 107, the output unit 108, and the super resolution unit 701 is referred to as a first group. A group of the data storage unit 105 and the basis storage unit 709 is referred to as a second group. Each unit included in the first group can be achieved by using the computer 10000 including the memory 10002 and a processor 10001 executing a program loaded in the memory 10002. Each unit included in the second group can be achieved by using the storage device 10003. Each unit included in the first group or the second group can be achieved by using dedicated hardware, such as one or more dedicated circuits.

The whole or part of the example embodiments disclosed above can be described as, but not limited to, the following 2 notes.

### SUPPLEMENTARY NOTES

### Supplementary Note 1

An information processing device including:

basis synthesis means for generating bases and first coefficient sets from first data, the bases with each of the first coefficient sets representing a piece of the first data; and

data synthesis means for determining a second coefficient set based on the first coefficient sets, the second coefficient set being different from the first coefficient sets, and synthesizing second data by using the bases and the second coefficient set.

### Supplementary Note 2

The information processing device according to Supplementary Note 1, wherein

the data synthesis means generates third data from the second data, resolution of the third data being lower in comparison with the second data, and

the image processing device further includes:

input means for receiving fourth data; and

execution means for generating a fifth data from the second data based on similarity between the third data and the fourth data and on relation between the second data and the third data.

### Supplementary Note 3

The information processing device according to Supplementary Note 1 or 2, wherein

the basis synthesis means determines a second coefficient associated with a basis in the bases so that the second coefficient is included within a range of first coefficients associated with the basis, the second coefficient being included in the second coefficient set, the first coefficients each being included in the first coefficient sets.

### Supplementary Note 4

The information processing device according to Supplementary Note 3, wherein

the basis synthesis means selects the second coefficient of the second coefficient set from the first coefficients of two or more of the first coefficient sets.

### Supplementary Note 5

An information processing method including:

generating bases and first coefficient sets from first data, the bases with each of the first coefficient sets representing a piece of the first data; and

determining a second coefficient set based on the first coefficient sets, the second coefficient set being different from the first coefficient sets, and synthesizing second data by using the bases and the second coefficient set.

### Supplementary Note 6

The information processing method according to Supplementary Note 5, including

generating third data from the second data, resolution of the third data being lower in comparison with the second data;

receiving fourth data; and

generating a fifth data from the second data based on similarity between the third data and the fourth data and on relation between the second data and the third data.

### Supplementary Note 7

The information processing method according to Supplementary Note 5 or 6, wherein

the determining the second coefficient set includes determining a second coefficient associated with a basis in the bases so that the second coefficient is included within a range of first coefficients associated with the basis, the second coefficient being included in the second coefficient set, the first coefficients each being included in the first coefficient sets.

### Supplementary Note 8

The information processing method according to Supplementary Note 7, wherein

the determining the second coefficient includes selecting the second coefficient of the second coefficient set from the first coefficients of two or more of the first coefficient sets.

### Supplementary Note 9

A storage medium storing a program causing a computer to operate:

basis synthesis processing of generating bases and first coefficient sets from first data, the bases with each of the first coefficient sets representing a piece of the first data; and

data synthesis processing of determining a second coefficient set based on the first coefficient sets, the second coefficient set being different from the first coefficient sets, and synthesizing second data by using the bases and the second coefficient set.

### Supplementary Note 10

The storage medium according to Supplementary Note 9, wherein the data synthesis processing generates third data from the second data, resolution of the third data being lower in comparison with the second data, and the program further causing a computer to operate:

input processing of receiving fourth data; and

execution processing of generating a fifth data from the second data based on similarity between the third data and the fourth data and on relation between the second data and the third data.

### Supplementary Note 11

The storage medium according to Supplementary Note 9 or 10, wherein

the basis synthesis processing determines a second coefficient associated with a basis in the bases so that the second coefficient is included within a range of first coefficients associated with the basis, the second coefficient being included in the second coefficient set, the first coefficients each being included in the first coefficient sets.

### Supplementary Note 12

The storage medium according to Supplementary Note 11, wherein

the basis synthesis processing selects the second coefficient of the second coefficient set from the first coefficients of two or more of the first coefficient sets.

While the present invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention can be used for protection of dictionary which contains privacy information and is used in exemplar based super resolution system.

When data containing privacy information such as faces, voice are used as dictionary in exemplar based super-resolution system, the dictionary has to be included in the system when the system is sold or distributed, and the personal information included in the system is unprotected.

### REFERENCE SIGNS LIST

100 Information processing device
101 Super resolution unit
102 First input unit
103 Basis synthesis unit
104 Data synthesis unit
105 Data storage unit
106 Second input unit
107 Super resolution execution unit
108 Output unit
201 Images
202 Image
700 Information processing device
701 Super resolution unit
709 Basis storage unit
1000 Information processing device
10000 Computer
10001 Processor
10002 Memory
10003 Storage device
10004 I/O interface
10005 Storage medium

What is claimed is:

1. An information processing device comprising:
at least one memory that stores a set of instructions; and
at least one processor configured to execute the set of instructions to:
generate bases and first coefficient sets from first data, the bases with each of the first coefficient sets representing a piece of the first data; and
determine a second coefficient set based on the first coefficient sets, the second coefficient set being different from the first coefficient sets, and synthesize second data by using the bases and the second coefficient set.

2. The information processing device according to claim 1, wherein
the at least one processor is further configured to:
generate third data from the second data, resolution of the third data being lower in comparison with the second data;
receive fourth data; and
generate a fifth data from the second data based on similarity between the third data and the fourth data and on relation between the second data and the third data.

3. The information processing device according to claim 1, wherein
the at least one processor is further configured to
determine a second coefficient associated with a basis in the bases so that the second coefficient is included within a range of first coefficients associated with the basis, the second coefficient being included in the second coefficient set, the first coefficients each being included in the first coefficient sets.

4. The information processing device according to claim 3, wherein
the at least one processor is further configured to
select the second coefficient of the second coefficient set from the first coefficients of two or more of the first coefficient sets.

5. An information processing method comprising:
generating bases and first coefficient sets from first data, the bases with each of the first coefficient sets representing a piece of the first data; and
determining a second coefficient set based on the first coefficient sets, the second coefficient set being different from the first coefficient sets, and synthesizing second data by using the bases and the second coefficient set.

6. The information processing method according to claim 5, comprising
generating third data from the second data, resolution of the third data being lower in comparison with the second data;
receiving fourth data; and
generating a fifth data from the second data based on similarity between the third data and the fourth data and on relation between the second data and the third data.

7. The information processing method according to claim 5, wherein
the determining the second coefficient set includes determining a second coefficient associated with a basis in the bases so that the second coefficient is included within a range of first coefficients associated with the basis, the second coefficient being included in the second coefficient set, the first coefficients each being included in the first coefficient sets.

8. The information processing method according to claim 7, wherein
the determining the second coefficient includes selecting the second coefficient of the second coefficient set from the first coefficients of two or more of the first coefficient sets.

9. A non-transitory computer readable storage medium storing a program causing a computer to operate:
basis synthesis processing of generating bases and first coefficient sets from first data, the bases with each of the first coefficient sets representing a piece of the first data; and
data synthesis processing of determining a second coefficient set based on the first coefficient sets, the second coefficient set being different from the first coefficient sets, and synthesizing second data by using the bases and the second coefficient set.

10. The storage medium according to claim 9, wherein
the data synthesis processing generates third data from the second data, resolution of the third data being lower in comparison with the second data, and
the program further causing a computer to operate:
input processing of receiving fourth data; and
execution processing of generating a fifth data from the second data based on similarity between the third data and the fourth data and on relation between the second data and the third data.

11. The storage medium according to claim 9, wherein
the basis synthesis processing determines a second coefficient associated with a basis in the bases so that the second coefficient is included within a range of first coefficients associated with the basis, the second coefficient being included in the second coefficient set, the first coefficients each being included in the first coefficient sets.

12. The storage medium according to claim 11, wherein
the basis synthesis processing selects the second coefficient of the second coefficient set from the first coefficients of two or more of the first coefficient sets.
